(19) United States
(12) Patent Application Publication
(10) Pub. No.: US 2023/0202180 A1
(43) Pub. Date: Jun. 29, 2023

(54) WASTE LIQUID COLLECTION DEVICE AND LIQUID DISCHARGE APPARATUS

(71) Applicants: Hiroyoshi Matsumoto, KANAGAWA (JP); Kazuyoshi Matsumoto, TOKYO (JP); Takeyuki Kobayashi, KANAGAWA (JP); Tetsu Morino, KANAGAWA (JP); Kenta Takahashi, KANAGAWA (JP)

(72) Inventors: Hiroyoshi Matsumoto, KANAGAWA (JP); Kazuyoshi Matsumoto, TOKYO (JP); Takeyuki Kobayashi, KANAGAWA (JP); Tetsu Morino, KANAGAWA (JP); Kenta Takahashi, KANAGAWA (JP)

(73) Assignee: Ricoh Company, Ltd., Tokyo (JP)

(21) Appl. No.: 18/067,227

(22) Filed: Dec. 16, 2022

(30) Foreign Application Priority Data
Dec. 23, 2021 (JP) 2021-209630

(51) Int. Cl. B41J 2/17

(52) U.S. Cl. CPC B41J 2/1721

(57) ABSTRACT

A waste liquid collection device includes: a tank housing that stores a liquid; a tubular member that causes the liquid to flow into the tank housing; a distance holding device disposed at an end portion of the tubular member suspended in an internal space of the tank housing; and a buoyancy imparting device having buoyancy for the liquid and causes the distance holding device to float on a liquid surface of the liquid, while keeping a certain distance between the end portion of the tubular member and the liquid surface using the buoyancy of the buoyancy imparting device. A liquid discharge apparatus includes the waste liquid collection device.

### CROSS-REFERENCE TO RELATED APPLICATIONS

This patent application is based on and claims priority pursuant to 35 U.S.C. §119(a) to Japanese Patent Application No. 2021-209630, filed on Dec. 23, 2021, in the Japan Patent Office, the entire disclosure of which is hereby incorporated by reference herein.

### BACKGROUND

### Technical Field

The present disclosure relates to a waste liquid collection device and a liquid discharge apparatus.

### Related Art

A liquid discharge apparatus including a liquid discharge unit that discharges a liquid onto a medium to form an image may perform a discharge operation for maintenance in addition to a discharge operation for image formation to prevent a decrease in discharge performance due to solidification or thickening of the liquid by drying. The liquid discharged in the discharge operation for maintenance is collected as a waste liquid, and hence some liquid discharge apparatuses are equipped with a waste liquid collection device. The waste liquid collection device includes a waste liquid tank that stores a waste liquid, and is equipped with a sensor that detects the amount of waste liquid stored in the waste liquid tank. The sensor provides a full detection function of detecting that the waste liquid is full.

### SUMMARY

According to an embodiment, a waste liquid collection device includes a tank housing that stores a liquid; a tubular member that causes the liquid to flow into the tank housing; a distance holding device disposed at an end portion of the tubular member suspended in an internal space of the tank housing; and a buoyancy imparting device that has buoyancy for the liquid and that causes the distance holding device to float on a liquid surface of the liquid. The distance holding device keeps a certain distance between the end portion of the tubular member and the liquid surface using the buoyancy of the buoyancy imparting device.

According to another embodiment, a waste liquid collection device includes a tank housing that stores a liquid; a liquid tube that causes the liquid to flow into the tank housing; a tube float disposed at an end portion of the liquid tube suspended in an internal space of the tank housing. The tube float includes a section having buoyancy for the liquid, which causes the tube float to float on a liquid surface of the liquid, the tube float being configured to keep a certain distance between the end portion of the liquid tube and the liquid surface using the buoyancy of the tube float.

According to another embodiment, a liquid discharge apparatus includes a conveyance device that conveys a recording medium; a liquid discharge unit that discharges a liquid onto the recording medium; and the waste liquid collection device. The waste liquid collection device collects a liquid that is discarded as a result that the liquid discharge unit executes a liquid discharge operation.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1A is a perspective view of an ultraviolet (UV) inkjet apparatus according to an embodiment of the present disclosure;

FIG. 1B is a cross-sectional view of the UV inkjet apparatus taken along an X-Z plane in FIG. 1A;

FIGS. 2A and 2B are views illustrating a disadvantage in a comparative example of the waste liquid collection device according to the embodiment of the present disclosure;

FIG. 3 is a schematic view illustrating a configuration of the waste liquid collection device according to an embodiment of the present disclosure;

FIG. 4 is a schematic view illustrating an example of an operation of the waste liquid collection device according to the embodiment;

FIG. 5 is an enlarged view illustrating an example of a characteristic portion included in the waste liquid collection device according to the embodiment;

FIG. 6 is a view illustrating an advantageous effect of the above-described characteristic portion;

FIGS. 7A and 7B are enlarged views illustrating another example of the characteristic portion included in the waste liquid collection device according to the embodiment;

FIGS. 8A to 8C are enlarged views illustrating still another example of the characteristic portion included in the waste liquid collection device according to the embodiment;

FIG. 9 is a plan view illustrating an example of a liquid discharge apparatus according to the embodiment of the present disclosure;

FIG. 10 is a side view of a major part illustrating an example of a liquid discharge unit according to the embodiment of the present disclosure;

FIG. 11 is a plan view of a major part illustrating an example of the liquid discharge unit according to the embodiment of the present disclosure; and

FIG. 12 is a front view illustrating another example of the liquid discharge unit according to the embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a”, “an”, and “the” are intended to include the plural forms as well, unless the context clearly indicates otherwise.

A waste liquid collection device and a liquid discharge apparatus according to embodiments of the present disclosure are described below with reference to the drawings.

A waste liquid collection device according to at least one embodiment of the present disclosure can continue collection of a waste liquid regardless of the position of a waste liquid surface in a waste liquid tank.

The waste liquid collection device of the related art is provided with a float switch that detects the amount of waste liquid based on the position of a float floated on the waste liquid. However, the float switch sometimes does not normally operate when dealing with a waste liquid that is likely to be adhered or solidified.

To address such a disadvantage, there is known a liquid amount detection device that can determine that abnormality occurs in the float based on detection content and detect normality of an operation of the full detection function regardless of the type of liquid.

Typically, a waste liquid is supplied to a waste liquid tank via a tube, naturally falls into the tank through an opening of the tube suspended in the waste liquid tank, and is stored. In this case, when the amount of waste liquid in the waste liquid tank increases and the liquid surface of the waste liquid rises, the distal end of the tube is submerged in the waste liquid. The waste liquid collection device has a configuration of pushing out the waste liquid to the waste liquid tank by using a pressurizer such as a pump; however, in a case where the liquid pressure at the distal end of the tube is higher than the pressure by the pump, a failure occurs in collection of the waste liquid when a maintenance operation is executed thereafter.

That is, according to the related art, there are disadvantages that it is difficult to collect the waste liquid, and the waste liquid remaining in the tube after the pump is stopped flows backward to the liquid discharge unit.

In view of the above, the waste liquid collection device according to at least one embodiment of the present disclosure can continuously collect the waste liquid regardless of the position of the waste liquid surface in the waste liquid tank.

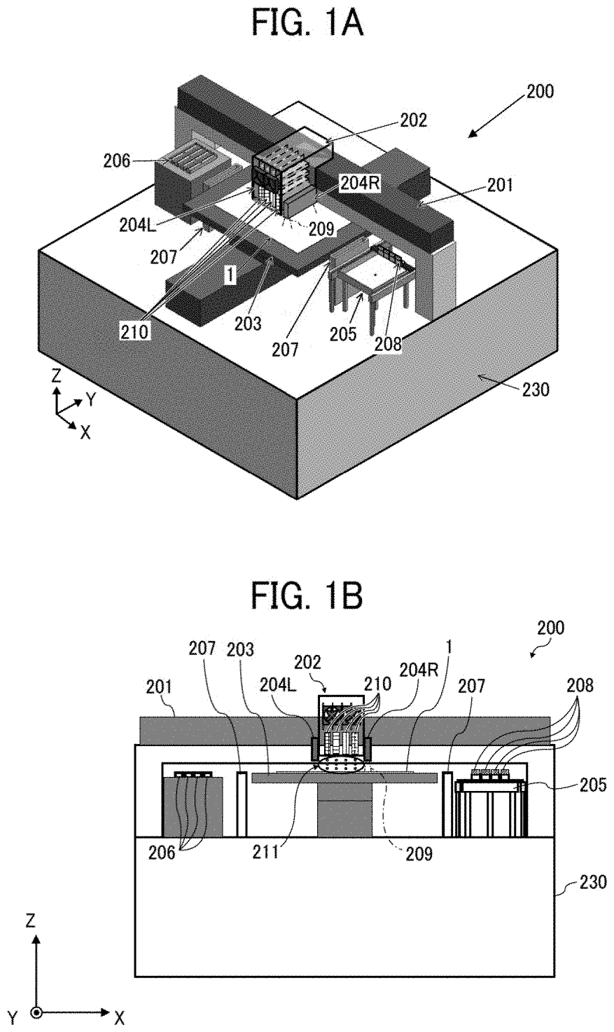

A UV inkjet apparatus 200 as a liquid discharge apparatus according to an embodiment of the present disclosure is described with reference to FIGS. 1A and 1B. FIG. 1A is a perspective external view of the UV inkjet apparatus 200 seen obliquely. FIG. 1B is a cross-sectional view of the UV inkjet apparatus 200 taken along an X-Z plane at a position near the center in the Y direction.

In the UV inkjet apparatus 200, a section with a function of discharging an ultraviolet curable ink (UV ink 211) is disposed on an apparatus base 230. With an operation of this section, the UV ink 211 is discharged toward a recording medium 1 placed on a linear stage 203 to form an image on the recording medium 1.

In the following description, the three-dimensional orthogonal coordinate system illustrated in FIGS. 1A and 1B may be used to describe the arrangement and operation of each component. As illustrated in FIGS. 1A and 1B, in the UV inkjet apparatus 200, components are disposed on a top surface of the apparatus base 230 having a bottom surface parallel to an X-Y plane. The apparatus base 230 has a predetermined height in a height direction that is the Z direction. It is assumed that a waste liquid collection device according to an embodiment of the present disclosure is mounted in the apparatus base 230 having the thickness in the Z direction.

Note that the positional relationship between the waste liquid collection device and the apparatus base 230 is not limited thereto.

Even though a configuration similar to that of a waste liquid collection device (described later) is provided at a position spaced apart from the apparatus base 230, advantageous effects similar to those according to the embodiment are obtained.

The UV inkjet apparatus 200 includes a linear actuator 201 that moves a carriage 202 in the X direction. The linear actuator 201 includes a long member having a longitudinal direction in the X direction.

The carriage 202 movable in the X direction by the linear actuator 201 is equipped with a plurality of inkjet heads 210. Each of the inkjet heads 210 has nozzles that are discharge ports of the UV ink 211. The nozzles define a nozzle surface in which the nozzles are two-dimensionally arrayed in a surface of the inkjet head 210 facing the linear stage 203. The inkjet head 210 can be reciprocated in the X direction by the carriage 202. The carriage 202 is also equipped with an actuator that causes the carriage 202 to be movable in the Z direction, and hence the carriage 202 can be moved in the Z direction.

The linear stage 203 is movable in the Y direction while the recording medium 1 is placed on the linear stage 203. With the movement of the linear stage 203 in the Y direction and the movement of the carriage 202 in the X direction, the inkjet head 210 can perform two-dimensional scanning along an X-Y plane with respect to the recording medium 1. The scanning timing of the inkjet head 210 and the discharge timing of the UV ink 211 (ultraviolet curable ink) with respect to the recording medium 1 are controlled, so that an image with the UV ink 211 can be formed on the recording medium 1.

The linear stage 203 also includes a rotation mechanism that can rotate around a rotation axis in the Z direction, and rotate around rotation axes in the Y direction and the X direction, in addition to the planar movement in the Y direction. The UV inkjet apparatus 200 can process recording media 1 having various shapes by movement of the linear actuator 201 in the X direction, movement of the linear stage 203 in the Y direction, and rotation of the linear stage 203. The linear stage 203 corresponds to a conveyance device.

The surface of the linear stage 203 has fine holes at regular intervals, and a vacuum pressure generation source such as a vacuum pump mounted in the apparatus base 230 is communicated to the holes. Thus, a thin recording medium 1 such as a film placed on the linear stage 203 can be attracted and secured to the linear stage 203. The recording medium 1 may be, instead of a sheet-shaped film, a plate member (of wood, metal, or resin) having a certain thickness. When recording media 1 having different thicknesses are used, the carriage 202 is moved in the Z direction to maintain proper distances among the recording medium 1, the inkjet head 210, and UV lamps 204.

The discharge operation of the UV ink 211 is controlled by a controller (such as circuitry) included in the UV inkjet apparatus 200. UV lamps 204 that emit ultraviolet rays for curing the UV ink 211 which has landed on the recording medium 1 are mounted on the left (left UV lamp 204L) and right (right UV lamp 204R) of the carriage 202. The UV lamps 204 each correspond to an ultraviolet irradiation device and irradiates the recording medium 1 with ultraviolet rays (UV light) 209. FIG. 1B illustrates a situation where the recording medium 1 is irradiated with the UV light 209 from the right UV lamp 204R. The UV lamps 204 each may use, for example, a focus UV lamp 204, instead of the diffuse UV lamp 204 illustrated in FIG. 1B. The UV lamps 204 may be selected from various types in accordance with the purpose.

A sub-tank included in each of the inkjet heads 210 is replenished with the UV ink 211 from a main tank mounted in the apparatus base 230. When the amount of the UV ink 211 in the sub-tank decreases, the controller operates a supply pump provided in the apparatus base 230 to replenish the UV ink 211 from the main tank to the sub-tank via a supply tube. The sub-tank is controlled by the controller to have a very small negative pressure suitable for discharge of the UV ink 211 using an air pipe, a solenoid valve, and an air-negative-pressure forming pump.

The air pipe provided in the sub-tank is also coupled to a pressure source for air pressurization via the solenoid valve. The pressure source for air pressurization is used when a normal discharge operation is not possible because, for example, dusts or bubbles exist in the nozzles of the inkjet head 210. In this case, the inkjet head 210 is moved to above a waste liquid receiver 205, and the pressure source for air pressurization is operated to switch the state of the sub-tank from the negative pressure to pressurization, thereby forcedly discharging the UV ink 211 from (the nozzles of) the inkjet head 210. By the forced discharge, dusts or bubbles existing in the nozzles of the inkjet head 210 can be pushed out.

If the UV ink 211 remains after pushed out from the nozzles of the inkjet head 210, the UV ink 211 may adhere to the nozzle surface, possibly leading to a failure in the subsequent discharge operation. Thus, an operation (wiping) of wiping the nozzle surface is executed on the ink jet head 210 after the forced discharge operation is performed. Wiping is an operation of wiping the nozzle surface using a wiper 208 that is provided movably in the Y direction, and is an example of a maintenance operation on the inkjet head 210. The wiper 208 is typically made of an elastic member, such as rubber or elastomer.

The UV ink 211 pushed out from the nozzles and the UV ink 211 wiped off by wiping are collected in a waste liquid tank 110 provided in the apparatus base 230 via the waste liquid receiver 205. The waste liquid tank 110 will be described later together with the description of a collection device 100 as a waste liquid collection device according to an embodiment of the present disclosure.

A cap 206 is disposed above the top surface of the apparatus base 230 at a position near an end portion in the longitudinal direction of the linear actuator 201. The cap 206 is secured at a position at a predetermined height from the top surface of the apparatus base 230. The cap 206 is provided to cover the inkjet head 210 for protection of the nozzle surface and protection of the ink in the vicinity of the nozzle surface in a case where the UV inkjet apparatus 200 is not used for a long period of time, such as when use of the UV inkjet apparatus 200 is ended.

Moreover, a dummy discharge receptacle 207 is disposed on the top surface of the apparatus base 230 at a position near an end portion in the longitudinal direction of the linear actuator 201 and near the cap 206. Another dummy discharge receptable 207 is disposed on the top surface of the apparatus base 230 at a position near another end portion in the longitudinal direction of the linear actuator 201 and near the waste liquid receiver 205. For simplicity, the dummy discharge receptables 207 may be collectively referred to as the dummy discharge receptable 207. The dummy discharge receptacle 207 is a member that receives the UV ink 211 to be discarded when the UV ink 211 deteriorated, for example, by being exposed to air is discarded by so-called “dummy discharge”. Using the dummy discharge receptacle 207, the inkjet head 210 performs a discharge operation (dummy discharge) not accompanied by image formation, thereby supplying the fresh UV ink 211 to the nozzles of the inkjet head 210. The quality of image formation can be maintained by the dummy discharge. Thus, the dummy discharge is performed at the start of use of the UV inkjet apparatus 200 or even in an interval between image forming operations when the use is continued for a certain period of time. The UV ink 211 discharged by the dummy discharge is also collected in the waste liquid tank 110 (described later).

FIG. 1A and FIG. 1B illustrate a state in which the carriage 202 discharges the UV ink 211 onto the recording medium 1 to form an image while moving from the positive direction to the negative direction of the X-axis. When the carriage 202 moves in the negative X direction (−X direction) while discharging the UV ink 211, the UV ink 211 lands on the recording medium 1, and then the right UV lamp 204R mounted in the positive X direction (+X direction) with respect to the inkjet heads 210 irradiates the UV ink 211 on the recording medium 1 with ultraviolet rays. Thus, the effect of the UV ink 211 adhering to the recording medium 1 is started.

While the carriage 202 is moving in the +X direction, the UV light 209 is emitted from the left UV lamp 204L mounted in the −X direction with respect to the inkjet heads 210 to cure the UV ink 211 which has landed on the recording medium 1. When the curability of the UV ink 211 is poor merely using one of the UV lamps 204 and an integrated quantity of ultraviolet rays is desirable, the UV light 209 may be emitted from both the left and right UV lamps 204.

Next, a collection device 100 as a waste liquid collection device according to an embodiment of the present disclosure is described. The collection device 100 according to the embodiment can be mounted in a housing different from the housing of the UV inkjet apparatus 200. In this case, a waste liquid 111 may be transferred from the waste liquid receiver 205 or the dummy discharge receptacle 207 to the waste liquid tank 110 via a waste liquid tube 120 (described later).

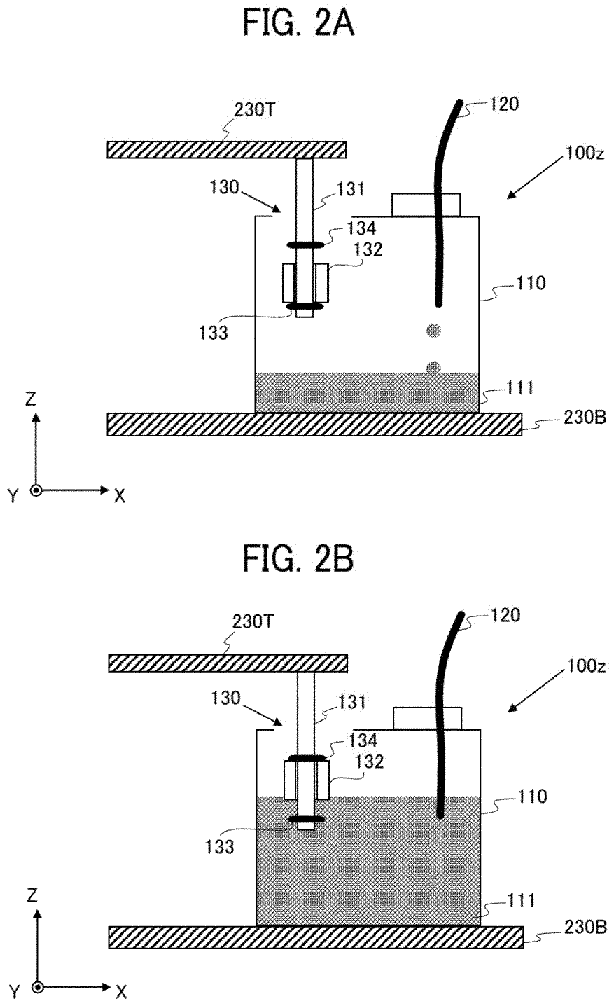

To clarify the characteristics of the present disclosure, an example of a collection device 100z having a configuration according to a comparative example is described with reference to FIGS. 2A and 2B. FIGS. 2A and 2B are configuration views illustrating an example of an internal structure of the collection device 100z according to the comparative example obtained by removing a portion having a characteristic configuration according to the embodiment of the disclosure of the present application from the collection device 100. The collection device 100z as the comparative example with respect to the embodiment of the present disclosure and the collection device 100 according to the embodiment have a common portion. Thus, in the following description, components of the collection device 100z common to those of the collection device 100 are denoted by the same reference signs as the reference signs used in the collection device 100. The configuration with the same reference sign of the collection device 100 has a structure, an operation, and an effect similar to the structure, the operation, and the effect of the configuration of the collection device 100z.

The collection device 100z collects, for example, the UV ink 211 discharged by a liquid discharge operation that is not accompanied by formation of an image or the like by the inkjet heads 210.

The collection device 100z includes at least a waste liquid tank 110, a waste liquid tube 120, and a float switch 130 mounted in the apparatus base 230.

The waste liquid tank 110 is a vessel disposed on a bottom surface 230B in the apparatus base 230, and has a volume for storing a certain amount of waste liquid 111. An opening to which the waste liquid tube 120 is inserted and an opening to which a float switch shaft 131 that defines the float switch 130 is inserted are formed in an upper portion of the waste liquid tank 110. The waste liquid tank 110 corresponds to a tank housing.

The waste liquid tube 120 is a tube member that guides the UV ink 211 (waste liquid 111), which is collected in the dummy discharge receptacle 207 or the waste liquid receiver 205 and no longer used to the waste liquid tank 110. One end portion of the waste liquid tube 120 is coupled to the dummy discharge receptacle 207 or the waste liquid receiver 205, and the other end portion thereof is held in a state suspended in the internal space of the waste liquid tank 110. A pressurizer such as a suction pump is coupled to the waste liquid tube 120 to suck out the waste liquid 111 collected in the dummy discharge receptacle 207 or the waste liquid receiver 205 and send the waste liquid to the waste liquid tank 110.

The float switch 130 includes the float switch shaft 131, a float 132, a lower stopper 133, and an upper stopper 134.

The float switch shaft 131 is a rod-shaped member that has one end portion secured to a top surface 230T of the apparatus base 230 and the other end portion secured in a state suspended toward the inside of the waste liquid tank 110. For example, a reed switch is provided at a predetermined position in the float switch shaft 131. The operating state of the reed switch is detected by a controller (such as circuitry) included in the collection device 100z. The amount of the waste liquid 111 stored in the waste liquid tank 110 can be detected based on the operating state of the reed switch. The lower stopper 133 is attached to the outer periphery of a portion near the lower end of the float switch shaft 131. The upper stopper 134 is attached to the outer periphery at a position at a predetermined height from the lower stopper 133. The reed switch included in the float switch shaft 131 is mounted between the lower stopper 133 and the upper stopper 134.

The float 132 is attached to the float switch shaft 131 in a state in which the float 132 is movable in the upward and downward directions. The float 132 is formed of a material that floats on the waste liquid 111. The lower limit of the movable range of the float 132 is restricted by the lower stopper 133, and the upper limit thereof is similarly restricted by the upper stopper 134. That is, the float 132 can move upward and downward between the lower stopper 133 and the upper stopper 134. When the float 132 floats from the lower stopper 133 side to the upper stopper 134 side in accordance with the amount of the waste liquid 111, a magnet embedded in the float 132 moves upward along the float switch shaft 131. Due to the movement, the magnet in the float 132 operates the reed switch in the float switch shaft 131 to detect the amount of the waste liquid 111. That is, when the reed switch is operated, it can be determined that the waste liquid 111 is in a full state.

That is, as the amount of the waste liquid stored in the waste liquid tank 110 increases, the float 132 rises, and the state of the reed switch of the float switch 130 transitions to on (or off). The transition of the switch state is detected by the controller included in the collection device 100z, and it is determined that the amount of the waste liquid stored in the waste liquid tank 110 is full.

In the collection device 100z, the controller normally or periodically monitors the state of the float switch 130. The controller has a function of executing a process based on a predetermined sequence, such as, when the reed switch is turned on, notifying a user of that the reed switch is turned on. When the waste liquid 111 is full, the content of the waste liquid tank 110 is discarded and the waste liquid tank 110 is reused or is replaced with a new waste liquid tank 110. When the waste liquid 111 no longer exists in the waste liquid tank 110, the float switch 130 is turned off.

FIG. 2A illustrates a non-full state with the waste liquid (a state in which the float switch 130 does not detect being full). When the amount of the waste liquid 111 is small and the liquid surface does not reach the position at which the float 132 is floated, the float 132 is at a position at which the float 132 is in contact with the lower stopper 133. The lower stopper 133 prevents the float 132 from falling from the float switch shaft 131.

When the amount of the waste liquid 111 increases from the state in FIG. 2A, the position of the float 132 floating on the liquid surface of the waste liquid 111 rises.

FIG. 2B illustrates a full state with the waste liquid 111 (a state in which the float switch 130 detects being full). As illustrated in FIG. 2B, when the liquid surface of the waste liquid 111 rises to an upper portion of the waste liquid tank 110, the float 132 floats accordingly. The upward movement of the float 132 is restricted by the upper stopper 134. When the float 132 rises to a position at which the float 132 comes into contact with the upper stopper 134, the magnet provided in the float 132 operates the reed switch provided in the float switch shaft 131. Accordingly, the controller of the collection device 100z can determine that the waste liquid 111 is full.

As illustrated in FIG. 2B, when the distal end of the waste liquid tube 120 (an opening portion extending downward to the inside of the waste liquid tank 110) is at a position below the liquid surface of the waste liquid 111 before the waste liquid 111 becomes full, the distal end is submerged in the waste liquid 111.

The waste liquid 111 is pushed out to the waste liquid tank 110 by the suction pressure of the suction pump; however, there may be a situation in which a new waste liquid 111 is not pushed out from the distal end of the waste liquid tube 120 submerged in the waste liquid 111 by the suction pressure of the suction pump depending on the solidified state and viscosity of the waste liquid 111 already stored in the waste liquid tank 110.

### Characteristics of Collection Device 100

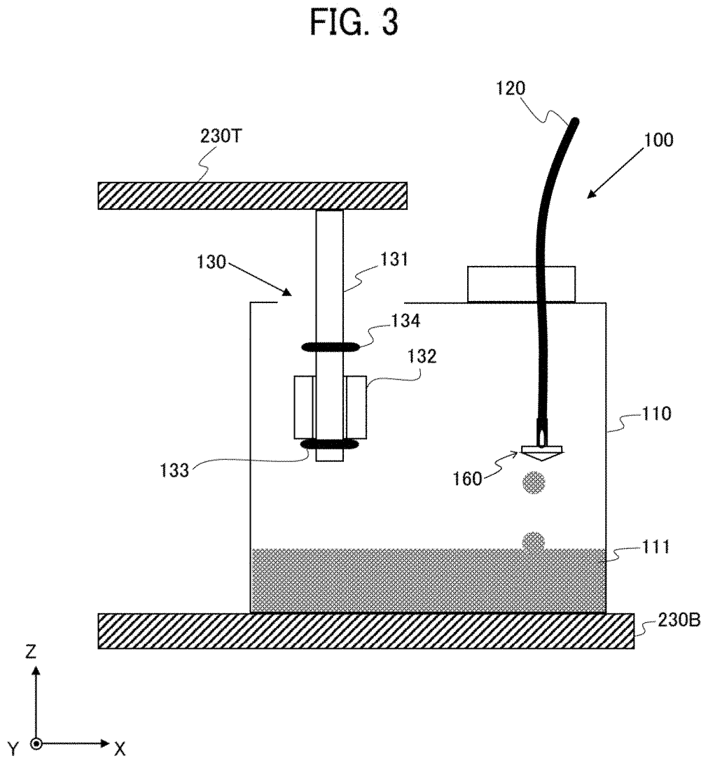

As described above, to prevent a failure from occurring in the collection of the new waste liquid 111, the collection device 100 according to the embodiment includes a tube float 160 at the distal end of the waste liquid tube 120. As illustrated in FIG. 3, in the collection device 100, the tube float 160 is provided at the distal end of the waste liquid tube 120, and has a structure that causes the waste liquid 111 collected via the waste liquid tube 120 to flow to the waste liquid tank 110.

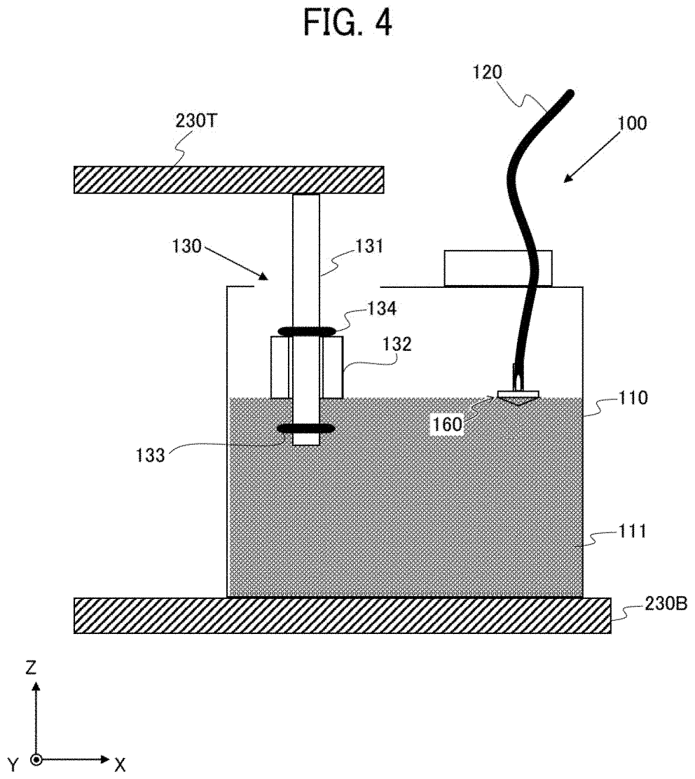

FIG. 4 schematically illustrates a state in the collection device 100 when the liquid surface of the waste liquid 111 rises and is higher than the distal end position of the suspended waste liquid tube 120. As illustrated in FIG. 4, the distal end of the waste liquid tube 120 is prevented from being submerged in the waste liquid 111 by the effect of the tube float 160.

The tube float 160 also serves as a buoyancy imparting member made of a material that exhibits buoyancy for the waste liquid 111. Thus, when the liquid surface of the waste liquid 111 rises, the distal end portion of the waste liquid tube 120 also rises by the tube float 160. Since the waste liquid tube 120 is formed of an elastic member, the entire waste liquid tube 120 can be moved upward by the upward movement of the distal end portion of the waste liquid tube 120.

The tube float 160 also functions as a distance holding device that causes the opening at the distal end of the waste liquid tube 120 to remain at a position at a certain distance from the liquid surface of the waste liquid 111. The distance holding device maintains a state in which the waste liquid 111 can continue to drip from the waste liquid tube 120 to the waste liquid tank 110. More specifically, as illustrated in FIG. 4, the distal end of the waste liquid tube 120 is kept at a position, above the liquid surface, for example, by a height of a floated portion of the tube float 160 (such as the height of the distance holding member 161).

### FIRST EMBODIMENT

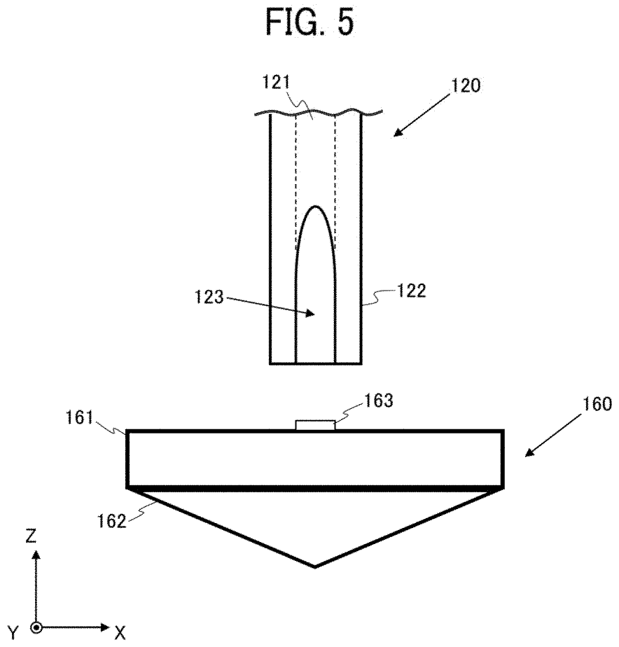

Next, a first embodiment of the waste liquid tube 120 and the tube float 160 included in the collection device 100 will be described referring to FIG. 5. FIG. 5 is a side view illustrating a state in which the waste liquid tube 120 and the tube float 160 are separated from each other.

As illustrated in FIG. 5, the waste liquid tube 120 is a tubular member having a hollow portion 121 through which the waste liquid 111 passes. The waste liquid tube 120 is made of an elastic member, such as silicon or rubber, which does not cause a chemical reaction with the waste liquid 111 and whose deterioration over time is moderate. An opening 123 is formed in an outer peripheral portion 122 that forms an outer wall of the waste liquid tube 120.

The opening 123 is a waste liquid outflow port formed by cutting out a portion of a side surface of an end portion on an opening side that comes into contact with the tube float 160. The opening 123 is formed in a facing surface that faces the tube float 160. The opening 123 is configured such that the waste liquid 111 sent through the hollow portion 121 flows out of the opening 123 from the waste liquid tube 120 to the outside in a state in which the waste liquid tube 120 is fitted or joined to the opening 123.

As illustrated in FIG. 5, the tube float 160 includes a distance holding member 161 (a section of the tube float) serving as a distance holding device to hold the waste liquid tube 120 at a certain distance between the distal end position of the waste liquid tube 120 and the liquid surface of the waste liquid 111 stored in the waste liquid tank 110 without the distal end position of the waste liquid tube 120 directly coming into contact with the liquid surface of the waste liquid 111. The tube float 160 also includes a buoyancy imparting member 162 (a section of the tube float) serving as a buoyancy imparting device that imparts buoyancy to cause the distance holding member 161 to float on the liquid surface of the waste liquid 111.

The distance holding member 161 has a tube positioning portion 163 on a surface that faces the waste liquid tube 120. The tube positioning portion 163 is a protrusion having an outer diameter substantially equivalent to the diameter of the hollow portion 121 of the waste liquid tube 120. The hollow portion 121 is fitted or joined to the tube positioning portion 163 to integrate the waste liquid tube 120 and the tube float 160.

The buoyancy imparting member 162 has, for example, a conical shape as illustrated in FIG. 5, and is tapered in a direction in which a side surface thereof is immersed in the waste liquid 111. The shape of the buoyancy imparting member 162 is not limited thereto, and may be a flat-plate shape. Any shape may be employed as far as the distance holding member 161 can be floated on the liquid surface of the waste liquid 111 to cause the waste liquid tube 120 to be held at a certain distance from the waste liquid 111.

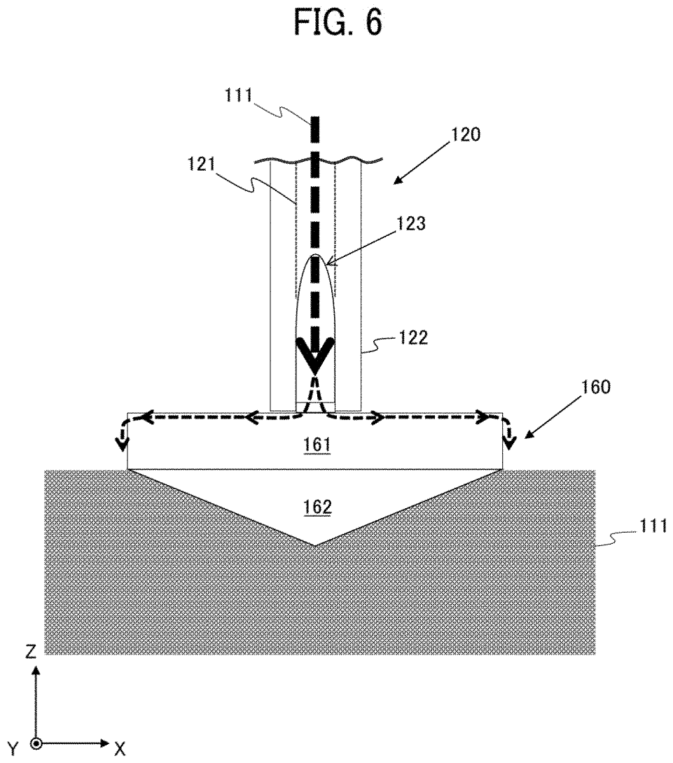

FIG. 6 is a view illustrating a way of flow of the waste liquid 111 in the integrated body of the waste liquid tube 120 and the tube float 160. In FIG. 6, the way of flow of the waste liquid 111 is indicated by broken-line arrows. In FIG. 6, indication of some reference signs is omitted.

As illustrated in FIG. 6, when the waste liquid 111 flows in the gravity direction along the hollow portion 121, the waste liquid 111 flows out from the opening 123 formed at the distal end on the downstream side onto the upper surface of the distance holding member 161.

The waste liquid 111 flowing out onto the upper surface of the distance holding member 161 flows on the upper surface of the distance holding member 161 due to the fluidity thereof, reaches the outer diameter, and then drips and flows downward from the distance holding member 161 in the gravity direction.

As described above, when the waste liquid 111 is pushed out of the opening 123 by the suction pump, the waste liquid 111 flows from the tube float 160 to the waste liquid tank 110 due to the fluidity of the waste liquid 111. At this time, since the opening 123 serving as the outflow port of the waste liquid 111 in the waste liquid tube 120 is at the position with the distance held without coming into contact with the liquid surface of the waste liquid 111, the disadvantage of the related art such as backflow due to solidification or an increase in viscosity of the waste liquid stored in the waste liquid tank 110 is addressed.

### SECOND EMBODIMENT

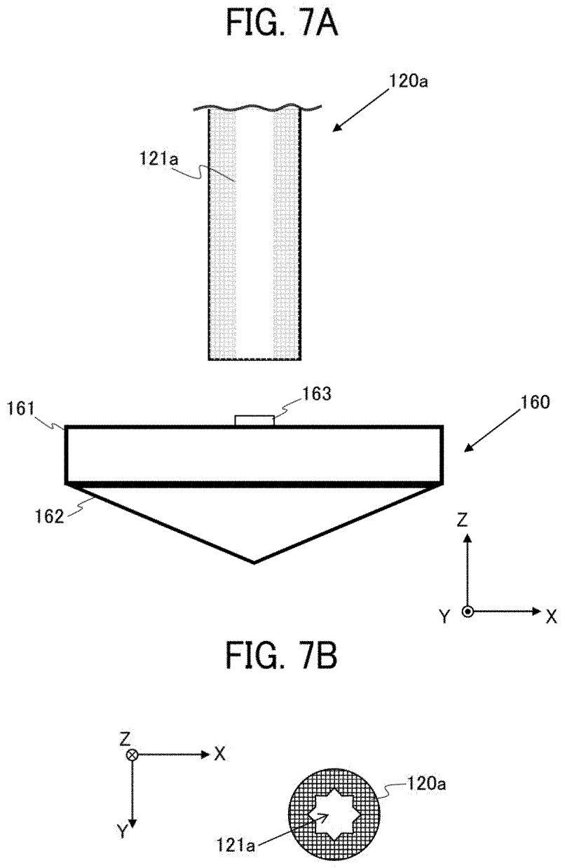

Next, a second embodiment of the waste liquid tube 120 included in the collection device 100 is described referring to FIGS. 7A and 7B. As illustrated in FIG. 7A, a waste liquid tube 120a according to the embodiment does not have the opening 123. Alternatively, the waste liquid tube 120a may have the opening 123. A discharge ink tube

FIG. 7B is a view of a distal end portion of the waste liquid tube 120a seen from the downstream side, and illustrates a cross-sectional shape of the waste liquid tube 120a. As illustrated in FIG. 7B, a hollow portion 121a of the waste liquid tube 120a does not have a circular tube shape, but has a substantially gear-shape in which protruding portions are circumferentially arranged.

When the hollow portion 121a is fitted to the tube positioning portion 163 of the distance holding member 161, the waste liquid 111 that has passed through a waste liquid tube 120b can flow out from the gap between the hollow portion 121a and the tube positioning portion 163. That is, instead of the opening 123 described in the first embodiment, the hollow portion 121a functions as an outflow port of the waste liquid 111, and hence the distal end portion of the waste liquid tube 120b can be held at a position floated above the upper surface of the distance holding member 161 to discharge the waste liquid 111. With this configuration, the tube float 160 floats on the liquid surface, such that the liquid surface is almost the same as a line determined by a boundary portion between the distance holing member 161 and the buoyancy imparting member 162.

### THIRD EMBODIMENT

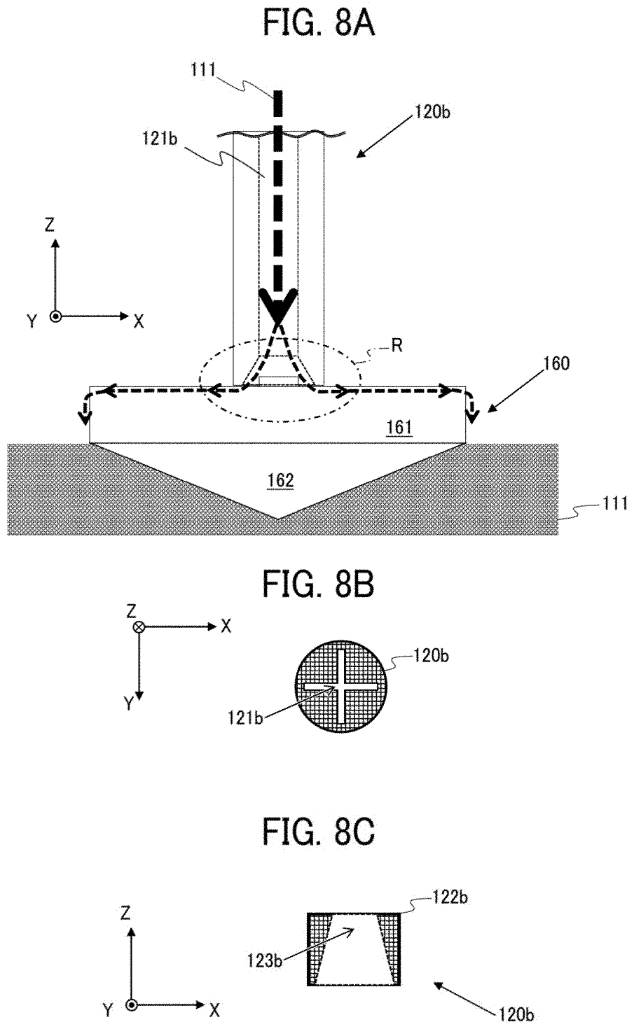

Next, a third embodiment of the waste liquid tube 120 included in the collection device 100 is described referring to FIGS. 8A to 8C. As illustrated in FIG. 8A, a waste liquid tube 120b according to the embodiment does not have the opening 123. Alternatively, the waste liquid tube 120b may have the opening 123.

FIG. 8B is a view of the waste liquid tube 120b seen from the upstream side, and illustrates a cross-sectional shape of the waste liquid tube 120b. As illustrated in FIG. 8B, the waste liquid tube 120b has a configuration in which the shape of a hollow portion 121b is not a circular tube shape, and the waste liquid 111 flows in a space defined by two notches intersecting with each other at the center.

FIG. 8C is an enlarged view of a region surrounded by a one-dot-chain-line circle R in FIG. 8A, and illustrates a shape of a distal end portion of the waste liquid tube 120b in an enlarged manner. As illustrated in FIG. 8C, the shape in vertical section of a portion that is a distal end portion of the hollow portion 121b and faces the distance holding member 161 has a divergent shape (gradually widening shape) in which the radial dimension expands toward the outflow port.

When the hollow portion 121b is fitted to the tube positioning portion 163 of the distance holding member 161, the waste liquid 111 that has passed through the waste liquid tube 120b passes through an inclined surface (inclined portion) of the distal end of the hollow portion 121b having the divergent shape, and flows out from the gap with respect to the tube positioning portion 163. The distal end of the hollow portion 121b is maintained in a state held at a predetermined position spaced apart from the liquid surface of the waste liquid 111 by the distance holding member 161.

That is, instead of the opening 123 described in the first embodiment, the hollow portion 121b functions as an outflow port of the waste liquid 111, and hence the distal end portion of the waste liquid tube 120b can be held at a position floated from the upper surface of the distance holding member 161 to discharge the waste liquid 111. Alternatively, the waste liquid tube 120b may additionally have the opening 123.

The collection device 100 according to the embodiment is used for an UV inkjet apparatus 200. The UV inkjet apparatus 200 includes a plurality of inkjet heads 210. The inkjet heads 210 may be collectively referred to as a “liquid discharge head” (For example, the liquid discharge head 404).

In the specification, the “liquid discharge head” is referred to as a section that discharges and ejects a liquid from a nozzle. The liquid to be discharged is not particularly limited to the ultraviolet curable ink as long as the liquid has a viscosity and a surface tension with which the liquid can be discharged from the head; however, it is expected that the liquid may interrupt the operation of the sensor that detects the full state of the tank that collects the waste liquid as described above. Thus, the liquid desirably has a viscosity of 30 mPa·ss or less at ordinary temperature and ordinary pressure, or by heating or cooling. Examples of the liquid include a solution, a suspension, or an emulsion that contains, for example, a solvent, such as water or an organic solvent, a colorant, such as dye or pigment, a functional material, such as a polymerizable compound, a resin, or a surfactant, a biocompatible material, such as deoxyribonucleic acid (DNA), amino acid, protein, or calcium, or an edible material, such as a natural colorant. The liquids can be used for, for example, applications such as an inkjet ink, a surface treatment liquid, a liquid for forming a resist pattern of a component or an electronic circuit of an electronic element or a light emitting element, and a three-dimensional fabricating material liquid.

Examples of the energy generation source for discharging a liquid include a piezoelectric actuator (a layered piezoelectric element or a thin-film piezoelectric element), a thermal actuator using an electrothermal conversion element such as a heating resistor, and an electrostatic actuator including a diaphragm and a counter electrode.

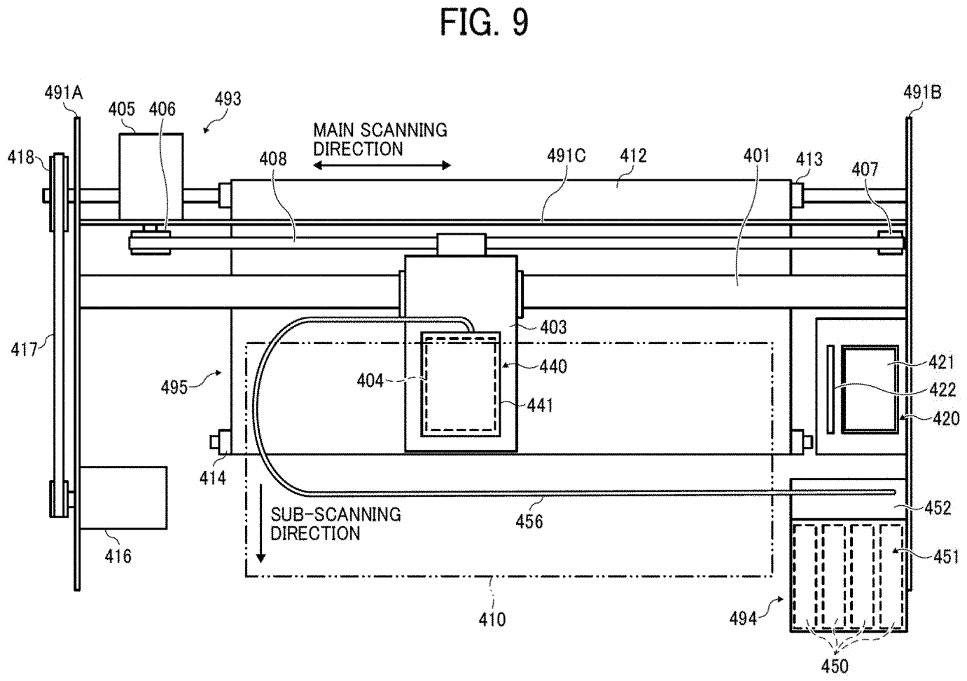

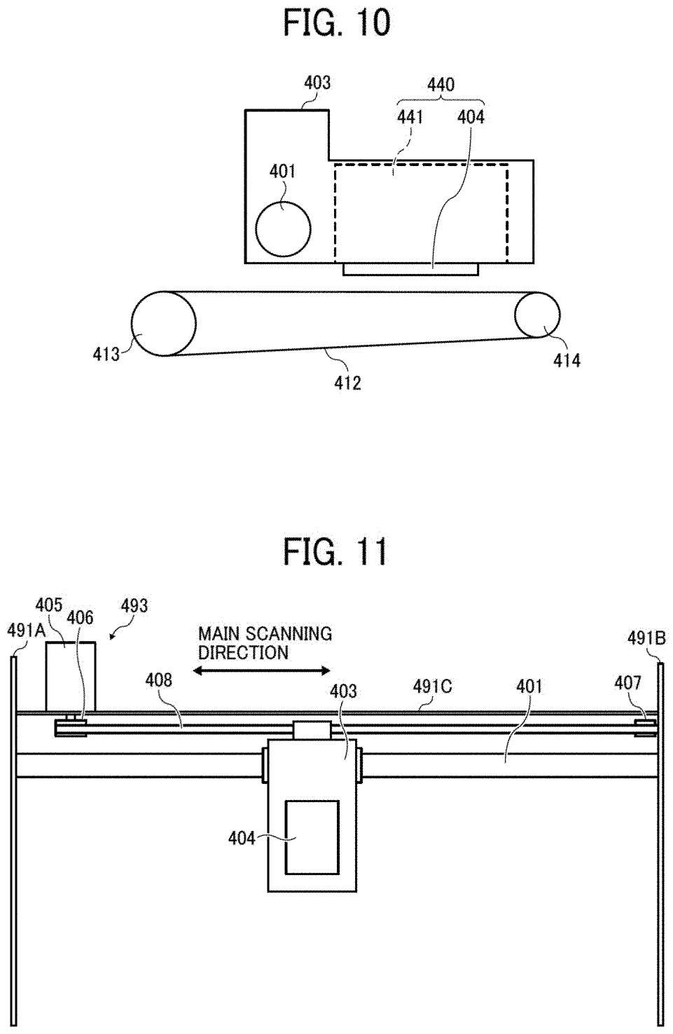

Next, a liquid discharge unit including a liquid discharge head, and a liquid discharge apparatus according to an embodiment of the present disclosure will be described. The liquid discharge apparatus according to the embodiment of the present disclosure is described first with reference to FIGS. 9 and 10. FIG. 9 is a plan view of a major part of a liquid discharge apparatus 400 according to the embodiment. FIG. 10 is a side view of a major part of the liquid discharge apparatus 400.

An example of the liquid discharge apparatus 400 is a serial-type apparatus. In the apparatus, a carriage 403 is reciprocated in a main-scanning direction by a main-scanning movement mechanism 493. The main-scanning movement mechanism 493 includes a guide member 401, a main-scanning motor 405, and a timing belt 408. The guide member 401 is bridged between left and right side plates 491A and 491B and holds the carriage 403 movably. The carriage 403 is reciprocated in the main-scanning direction by the main-scanning motor 405 via the timing belt 408 that is wound around a driving pulley 406 and a driven pulley 407.

The carriage 403 is equipped with a liquid discharge unit 440 (liquid discharge device) in which a liquid discharge head 404 and a head tank 441 are integrated.

The liquid discharge head 404 of the liquid discharge unit 440 discharges, for example, a liquid of each color of yellow (Y), cyan (C), magenta (M), and black (K). The liquid discharge head 404 has a nozzle row including a plurality of nozzles arranged in a sub-scanning direction orthogonal to the main-scanning direction and mounted with a discharge direction facing downward.

The liquid stored in a liquid cartridge 450 is supplied to the head tank 441 by a supply mechanism 494 that supplies the liquid stored outside the liquid discharge head 404, to the liquid discharge head 404.

The supply mechanism 494 includes a cartridge holder 451 serving as a loading unit to which the liquid cartridge 450 is loaded, a tube 456, and a liquid feed unit 452 including a liquid feed pump. The liquid cartridge 450 is detachably attached to the cartridge holder 451. The liquid is fed from the liquid cartridge 450 to the head tank 441 by the liquid feed unit 452 via the tube 456.

The liquid discharge apparatus 400 includes a conveyance mechanism 495 that conveys a sheet 410. The conveyance mechanism 495 includes a conveyance belt 412 serving as a conveyor and a sub-scanning motor 416 that drives the conveyance belt 412.

The conveyance belt 412 attracts the sheet 410 and conveys the sheet 410 at a position facing the liquid discharge head 404. The conveyance belt 412 is an endless belt stretched between a conveyance roller 413 and a tension roller 414. The sheet 410 is attracted to the conveyance belt 412 by electrostatic force or air suction.

The conveyance roller 413 is rotationally driven by the sub-scanning motor 416 via a timing belt 417 and a timing pulley 418, and hence the conveyance belt 412 rotationally moves in the sub-scanning direction. Furthermore, on one side in the main-scanning direction of the carriage 403, a maintenance and recovery mechanism 420 that performs maintenance and recovery for the liquid discharge head 404 is disposed on a lateral side of the conveyance belt 412.

The maintenance and recovery mechanism 420 includes, for example, a cap member 421 that caps a nozzle surface (a surface provided with the nozzles) of 1 and a wiper member 422 that wipes the nozzle surface.

The main-scanning movement mechanism 493, the supply mechanism 494, the maintenance and recovery mechanism 420, and the conveyance mechanism 495 are attached to a housing including the side plates 491A and 491B, and a back plate 491C.

In the liquid discharge apparatus 400 having the above-described configuration, the sheet 410 is fed onto the conveyance belt 412, attracted thereto, and conveyed in the sub-scanning direction by the rotational movement of the conveyance belt 412. Then, the liquid discharge head 404 is driven in accordance with an image signal while the carriage 403 is moved in the main-scanning direction, and hence the UV ink 211 is discharged onto the stopped sheet 410 to form an image.

Next, an example of a liquid discharge unit according to the embodiment of the present disclosure is described referring to FIG. 11.

FIG. 11 is a plan view of a major part of the liquid discharge unit.

A liquid discharge apparatus 400 according to the embodiment includes, from among the parts included in the liquid discharge apparatus 400 serving as a liquid discharge apparatus, a housing portion defined by the side plates 491A and 491B, and the back plate 491C, the main-scanning movement mechanism 493, the carriage 403, and the liquid discharge head 404. At least one of the maintenance and recovery mechanism 420 or the supply mechanism 494 may be further attached to, for example, the side plate 491B of the liquid discharge unit to define a liquid discharge unit.

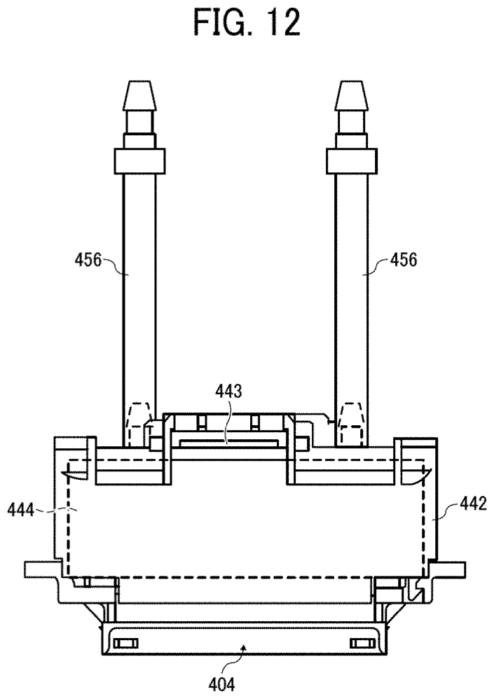

Next, another example of a liquid discharge unit that can be mounted on the liquid discharge apparatus according to the embodiment of the present disclosure is described referring to FIG. 12. FIG. 12 is a front view of the liquid discharge unit according to the embodiment.

The liquid discharge unit includes the liquid discharge head 404 to which a flow path part 444 is attached, and a tube 456 coupled to the flow path part 444. The flow path part 444 is disposed inside a cover 442. Instead of the flow path part 444, a head tank 441 may be included.

Moreover, a connector 443 that is electrically coupled to 1 is provided at an upper portion of the flow path part 444.

In the embodiments of the present disclosure described above, the “liquid discharge apparatus” is an apparatus that includes a liquid discharge head or a liquid discharge unit, and that drives the liquid discharge head to discharge a liquid. The “liquid discharge apparatus” used here includes, in addition to an apparatus to discharge a liquid to an object to which the liquid can adhere, an apparatus to discharge the liquid into a gas (air) or a liquid.

The “liquid discharge apparatus” may include a device related to feeding, conveyance, and ejection of an object to which a liquid can adhere, a pre-processing device, and a post-processing device.

Examples of the “liquid discharge apparatus” include an image forming apparatus to discharge an ink onto a sheet to form an image and a three-dimensional fabricating apparatus to discharge a molding liquid to a powder layer in which powder is molded into a layer-like shape, so as to form a three-dimensional fabricated object.

The “liquid discharge apparatus” is not limited to an apparatus in which a meaningful image such as a character or a figure is visualized using a discharged liquid. For example, the liquid discharge apparatus can be an apparatus to form a meaningless pattern, or an apparatus to fabricate a three-dimensional image.

The “object to which a liquid can adhere” represents an object to which a liquid can adhere even temporarily. The material of the “object to which a liquid adheres” may be any material to which a liquid can adhere even temporarily, such as paper, yarn, fiber, cloth, leather, metal, plastic, glass, wood, or ceramic.

Unless particularly limited, the “liquid discharge apparatus” includes a serial-type apparatus that moves a liquid discharge head and a line-type apparatus that does not move a liquid discharge head.

Examples of the “liquid discharge apparatus” also include a treatment liquid application apparatus that discharges a treatment liquid onto a sheet to apply the treatment liquid to the surface of the sheet for the purpose of modifying the surface of the sheet, and an injection granulation apparatus that injects a composition liquid having a raw material dispersed in a solution via a nozzle to granulate fine particles of the raw material.

The “liquid discharge unit” is an assembly of a functional part and a mechanism integrated with the liquid discharge head, and is an assembly of parts related to discharge of a liquid. For example, the “liquid discharge unit” includes a combination of at least one of a head tank, a carriage, a supply mechanism, a maintenance and recovery mechanism, or a main-scanning movement mechanism, and the liquid discharge head.

Herein, the term “combined” or “integrated” means attaching the liquid discharge head and the functional part (or mechanism) to each other by fastening, screwing, binding, or engaging and holding one of the liquid discharge head and the functional part to the other movably relative to the other. The liquid discharge head and the functional part or mechanism may be detachably attached to one another.

An example of the liquid discharge unit is a unit in which a liquid discharge head and a head tank are integrated as in the liquid discharge unit illustrated in FIG. 10. The liquid discharge head and the head tank may be coupled to each other via, for example, a tube to integrally form the liquid discharge unit. Here, a unit including a filter may further be added to a portion between the head tank and the liquid discharge head of the liquid discharge unit.

Another example of the liquid discharge unit is a unit in which a liquid discharge head and a carriage are integrated.

Still another example of the liquid discharge unit is a unit in which a liquid discharge head is movably held by a guide member defining a portion of a scanning movement mechanism, so that the liquid discharge head and the scanning movement mechanism are integrated. As illustrated in FIG. 11, there is a liquid discharge unit in which a liquid discharge head, a carriage, and a main-scanning movement mechanism are integrated.

Yet another example of the liquid discharge unit is a unit in which a cap member defining a portion of a maintenance and recovery mechanism is secured to a carriage to which a liquid discharge head is attached, so that the liquid discharge head, the carriage, and the maintenance and recovery mechanism are integrated.

Yet another example of the liquid discharge unit is a unit in which, as illustrated in FIG. 12, a tube is coupled to a liquid discharge head to which a head tank or a flow path part of a supply mechanism is attached, so that the liquid discharge head and the supply mechanism are integrated.

The main-scanning movement mechanism may include a guide member only. The supply mechanism may include a tube only or a loading unit only.

The “liquid discharge head” may use any pressure generator.

The pressure generator is not limited to the piezoelectric actuator (or the layered-type piezoelectric element) described in the above-described embodiments, and may be, for example, a thermal actuator that employs a thermoelectric conversion element, such as a thermal resistor or an electrostatic actuator including a diaphragm and a counter electrode.

In the present specification, image formation, recording, character printing, imprinting, printing, fabricating, and the like are synonymous.

The present disclosure is not limited to the embodiments described above, and various modifications can be made within the range not departing from the technical scope of the present disclosure. All the technical matters included in the technical idea as set forth in the appended claims are included in the present disclosure. It is therefore to be understood that, the present disclosure of the present specification may be practiced otherwise by those skilled in the art than as specifically described in the embodiments. Such modifications are also included in the technical scope as set forth in the appended claims.

1. A waste liquid collection device comprising:
a tank housing configured to store a liquid;
a tubular member configured to cause the liquid to flow into the tank housing;
a distance holding device disposed at an end portion of the tubular member suspended in an internal space of the tank housing; and
a buoyancy imparting device having buoyancy for the liquid and configured to cause the distance holding device to float on a liquid surface of the liquid, while keeping a certain distance between the end portion of the tubular member and the liquid surface using the buoyancy of the buoyancy imparting device.

2. The waste liquid collection device according to claim 1, wherein the end portion of the tubular member has an opening in a side surface with respect to a facing surface that faces the distance holding device.

3. The waste liquid collection device according to claim 1, wherein the end portion of the tubular member has a divergent inclined portion at a facing surface that faces the distance holding device.

4. A liquid discharge apparatus comprising:
a conveyance device configured to convey a recording medium;
a liquid discharge unit configured to discharge a liquid onto the recording medium; and
the waste liquid collection device according to claim 1, the waste liquid collection device being configured to collect a liquid that is discarded based on a result of executing a liquid discharge operation by the liquid discharge unit.

5. A waste liquid collection device comprising:
a tank housing configured to store a liquid;
a liquid tube configured to cause the liquid to flow into the tank housing; and
a tube float disposed at an end portion of the liquid tube suspended in an internal space of the tank housing,
the tube float including a section having buoyancy for the liquid that causes the tube float to float on a liquid surface of the liquid, while keeping a certain distance between the end portion of the liquid tube and the liquid surface using the buoyancy of the tube float.

6. The waste liquid collection device according to claim 5, wherein the end portion of the liquid tube has an opening in a side surface with respect to a facing surface that faces the tube float.

7. The waste liquid collection device according to claim 5, wherein the end portion of the liquid tube has a divergent inclined portion at a facing surface that faces the tube float.

8. A liquid discharge apparatus comprising:
a conveyance device configured to convey a recording medium;
a liquid discharge device configured to discharge a liquid onto the recording medium; and
the waste liquid collection device according to claim 5, the waste liquid collection device being configured to collect a liquid that is discarded based on a result of executing a liquid discharge operation by the liquid discharge unit.
